(19) United States
(12) Patent Application Publication
(10) Pub. No.: US 2023/0069873 A1
(43) Pub. Date: Mar. 9, 2023

(54) BATTERY CORE ASSEMBLY, BATTERY, BATTERY PACK AND VEHICLE

(71) Applicant: BYD COMPANY LIMITED, Shenzhen (CN)

(72) Inventors: Shichao HU, Shenzhen (CN); Yan ZHU, Shenzhen (CN); Xin GAO, Shenzhen (CN)

(21) Appl. No.: 17/988,006

(22) Filed: Nov. 16, 2022

Related U.S. Application Data
(63) Continuation of application No. PCT/CN2021/088457, filed on Apr. 20, 2021.

(30) Foreign Application Priority Data
May 18, 2020 (CN) 202010421322.9

(51) Int. Cl. H01M 50/176; H01M 50/103; H01M 50/249; H01M 50/209

(52) U.S. Cl. CPC H01M 50/176; H01M 50/103; H01M 50/249; H01M 50/209; H01M 2220/20

(57) ABSTRACT

The present disclosure provides a battery core assembly, a battery, a battery pack, and a vehicle. The battery core assembly includes an encapsulation film and an electrode core assembly. The electrode core assembly is arranged in an accommodating cavity defined by the encapsulation film, and the electrode core assembly includes at least one electrode core. The electrode core assembly includes a first electrode lead-out member and a second electrode lead-out member for current output, and a cap is arranged in the accommodating cavity at a first end portion of the electrode core assembly. The first end portion of the electrode core assembly has the first electrode lead-out member, and the cap includes an electrode lead-out hole, where the first electrode lead-out member passes through the electrode lead-out hole.

### CROSS-REFERENCE TO RELATED APPLICATIONS

The application is a continuation application of International Patent Application No. PCT/CN2021/088457 filed with the China National Intellectual Property Administration (CNIPA) on Apr. 20, 2021, which is based on and claims priority to and benefits of Chinese Patent Application No. 202010421322.9 filed on May 18, 2020. The entire content of all of the above-referenced applications is incorporated herein by reference.

### FIELD

The present disclosure relates to the field of batteries, and specifically to a battery core assembly, a battery, a battery pack, and a vehicle.

### BACKGROUND

With the continuous popularization of new energy vehicles, the requirements raised for use of power batteries in new energy vehicles are becoming increasingly higher. In particular, the users' requirements for the service life of power batteries becomes increasingly higher. Especially taxi, and buses are required to have a service life of more than 1 million kilometers over 5 years. For the sake of enhancing the capacity, multiple electrically connected battery cores are usually provided in existing batteries. The positive and negative terminals of the battery core are generally led out directly from both sides of the battery core, so the positive and negative terminals tend to wobble, adversely affecting the connection between the battery cores. For example, the battery cores may be easily disconnected, affecting the use of the battery.

### SUMMARY

The present disclosure resolves at least one of the technical problems existing in the related art.

To resolve the foregoing technical problem, the technical solutions of the present disclosure are as follows.

In a first aspect, the present disclosure provides a battery core assembly, which includes an encapsulation film and an electrode core assembly. The electrode core assembly is arranged in an accommodating cavity defined by the encapsulation film, and the electrode core assembly includes at least one electrode core.

The electrode core assembly includes a first electrode lead-out member and a second electrode lead-out member for current output.

A cap is arranged in the accommodating cavity at a first end portion of the electrode core assembly, the first end portion of the electrode core assembly has the first electrode lead-out member, and the cap includes an electrode lead-out hole. The first electrode lead-out member passes through the electrode lead-out hole.

In some embodiments of the present disclosure, an electrolyte solution is disposed in the accommodating cavity, and the cap includes a first liquid reservoir, and the first liquid reservoir is a recess recessed from an outer surface of the cap to an interior of the cap; and the first liquid reservoir communicates with the accommodating cavity.

In some embodiments of the present disclosure, the cap and the encapsulation film are coupled to allow the first liquid reservoir to communicate with the accommodating cavity.

In some embodiments of the present disclosure, the first liquid reservoir includes multiple reinforcing ribs to divide the first liquid reservoir into multiple liquid storage units.

In some embodiments of the present disclosure, a length of the at least one electrode core extends along a first direction, and a thickness of the at least one electrode core extends along a second direction perpendicular to the first direction, and the cap includes multiple first liquid reservoirs, and the multiple first liquid reservoirs are arranged along the second direction.

In some embodiments of the present disclosure, the electrode core assembly includes an electrode core assembly body and two electrode lead-out members electrically connected to the electrode core assembly body, and a length of the electrode core assembly body extends along a first direction.

The two electrode lead-out members are respectively led out from two opposite end portions of the electrode core assembly body in the first direction; and the battery core assembly includes two caps including the cap, and the two caps are respectively arranged at the two opposite end portions of the electrode core assembly body in the first direction.

In some embodiments of the present disclosure, a length of the at least one electrode core extends along the first direction, and a thickness of the at least one electrode core extends along and a second direction perpendicular to the first direction. The electrode core assembly body includes at least two electrode cores including the at least one electrode core, and the at least two electrode cores are connected and arranged along the second direction.

In some embodiments of the present disclosure, two adjacent electrode cores of the at least two electrode cores are connected in parallel. Each of the at least two electrode cores includes an electrode core body and two tabs, and the two tabs have opposite polarities and are electrically connected to the electrode core body. The two tabs are respectively arranged at two opposite ends of the electrode core body in the first direction. Two adjacent tabs having a same polarity respectively of the two adjacent electrode cores are located on a same end of the electrode core body, and the two adjacent tabs are electrically connected.

In some embodiments of the present disclosure, the electrode core assembly body further includes a tab support located on the end portions of the electrode core assembly body, and the tap support is electrically connected to and is disposed between the two adjacent tabs.

The first electrode lead-out member is electrically connected to the tab support.

In some embodiments of the present disclosure, the tab support is connected to the first electrode lead-out member and a corresponding tab on different surfaces of the tab support.

In some embodiments of the present disclosure, the tab support includes two first surfaces opposite to each other, and the two adjacent tabs are respectively attached to the two first surfaces of the tab support.

In some embodiments of the present disclosure, the tab support is a square piece, the square piece includes the two first surfaces, a third surface and a fourth surface located between the two first surfaces, and the third surface faces the electrode core body.

The tab support is connected to the first electrode lead-out member through the fourth surface.

In some embodiments of the present disclosure, the tab support has a hollow cavity.

In some embodiments of the present disclosure, the hollow cavity has an opening on at least one cavity wall to communicate with the electrode lead-out hole on the cap, and the hollow cavity forms a second liquid reservoir.

In some embodiments of the present disclosure, the tab support is a U-shaped piece having an opening, the U-shaped piece includes two opposite side walls and a bottom wall between the two opposite side walls, and outer surfaces of the two opposite side walls are the two first surfaces respectively.

In some embodiments of the present disclosure, the opening of the U-shaped piece faces the electrode core body, and the tab support electrically connected to the first electrode lead-out member through the bottom wall.

In some embodiments of the present disclosure, the opening of the U-shaped piece faces the cap, and the tab support electrically connected to the first electrode lead-out member through one of the side walls.

In some embodiments of the present disclosure, the opening of the U-shaped piece communicates with the electrode lead-out hole on the cap, and an cavity in the U-shaped piece forms a second liquid reservoir.

In some embodiments of the present disclosure, an insulating spacer is disposed between the tab support and the electrode core body.

In some embodiments of the present disclosure, each of two opposite ends of the electrode core body in the first direction has two surfaces forming a V-shaped end with a tip protruding outward and having a cross section of a V shape, the two tabs of each of the at least two electrode cores are respectively located at tips of the two V-shaped ends, and V-shaped ends of two adjacent electrode core bodies at a same end form a V-shaped space.

The insulating spacer has a shape matching the V-shaped space.

In some embodiments of the present disclosure, an angle of the V-shaped space is 90-150 degrees.

In some embodiments of the present disclosure, the insulating spacer is fixed to the tab support by a snap mechanism.

In some embodiments of the present disclosure, the cap has an accommodating space on a side of the cap facing the electrode core assembly body. An end portion of the electrode core assembly body is fitted in the accommodating space of the cap.

In a second aspect, the present disclosure provides a battery, which includes a casing, and at least one battery core assembly encapsulated in the casing, which is any one of the battery core assemblies as described above.

In a third aspect, the present disclosure provides a battery module, which includes multiple batteries as described above.

In a fourth aspect, the present disclosure provides a battery pack, which includes multiple batteries or multiple battery modules as described above.

In a fifth aspect, the present disclosure provides a vehicle, which includes a battery module or a battery pack as described above.

Compared with the related art, beneficial effects of the present disclosure are as follows.

According to the battery core assembly provided in the present disclosure, a cap is arranged in the encapsulation film at a side of the electrode core assembly having the electrode lead-out member, and provided with an electrode lead-out hole for the electrode lead-out member passing through. The electrode lead-out member is extended out of the electrode lead-out hole, to fix the electrode lead-out member with the aid of the cap, so that the electrode lead-out member is unlikely to wobble or move so that the connection is stable and reliable. Therefore, the service life of the battery core assembly can be extended.

### BRIEF DESCRIPTION OF THE DRAWINGS

FIG. 1 is a schematic structural view of a battery core assembly provided in a first embodiment of the present disclosure;

FIG. 2 is a front view of the battery core assembly shown in FIG. 1;

FIG. 3 is a schematic cross-sectional view of the battery core assembly shown in FIG. 2 along

FIG. 4 is a schematic structural view of the battery core assembly shown in FIG. 1, from which an encapsulation film is removed;

FIG. 5 is a schematic structural view of the battery core assembly shown in FIG. 4, from which a cap is removed;

FIG. 6 is a schematic exploded view of the battery core assembly provided in the first embodiment of the present disclosure;

FIG. 7 schematically shows the assembly of an insulating spacer, a tab support, and an electrode lead-out member provided in the first embodiment of the present disclosure;

FIG. 8 shows a disassembled structure of FIG. 7;

FIG. 9 is a schematic structural view of a tab support provided in another embodiment;

FIG. 10 is a schematic structural view of a battery core assembly provided in a second embodiment of the present disclosure;

FIG. 11 is a front view of the battery core assembly shown in FIG. 10;

FIG. 12 is a schematic cross-sectional view of the battery core assembly shown in FIG. 11 along XII-XII;

FIG. 13 is a schematic structural perspective view of a cap provided in the second embodiment of the present disclosure in one direction;

FIG. 14 is a left side view of the cap provided in the second embodiment of the present disclosure;

FIG. 15 is a schematic cross-sectional view of FIG. 14 along XV-XV;

FIG. 16 is a schematic structural perspective view of the cap provided in the second embodiment of the present disclosure in another direction;

FIG. 17 is a schematic structural view of a battery without a casing provided in an embodiment of the present disclosure;

FIG. 18 is a schematic structural view of a battery with a casing provided in an embodiment of the present disclosure;

FIG. 19 is a schematic structural view of a battery pack provided in an embodiment of the present disclosure; and

FIG. 20 is a schematic structural view of a vehicle provided in an embodiment of the present disclosure.

Reference numerals of the accompanying drawing:

battery core assembly 10; encapsulation film 11; accommodating cavity 110; electrode core assembly 12; electrode core 121; electrode core body 1211; tab 1213; electrode lead-out member 122; contact portion 1221; lead-out portion 1223; electrode core assembly body 123; tab support 124; hollow cavityl240; first surface 1241; third surface 1243; fourth surface 1244; bottom wall 1248; opening 1245; side wall 1247; insulating spacer 125; engaging hole 1246; buckle 1251; cap 13; opening 130; electrode lead-out hole 131; first liquid reservoir 132; reinforcing rib 1321; liquid storage unit 1322; inner cavity 133; accommodating space 134; Battery 100; battery pack 200; tray 22; casing 20; and vehicle 300.

### DETAILED DESCRIPTION

Embodiments of the present disclosure are described in detail below, and examples of the embodiments are shown in accompanying drawings, where the same or similar elements or the elements having same or similar functions are denoted by the same or similar reference numerals throughout the description. The embodiments described below with reference to the accompanying drawings are exemplary, and to explain the present disclosure and cannot be construed as a limitation on the present disclosure.

In the description of the present disclosure, it should be understood that, terms such as “length”, “width”, “up”, “down”, “front”, “rear”, “left”, “right”, “vertical”, “horizontal”, “top”, “bottom”, “inside”, and “outside” indicate an orientation or position relationship based on the orientation or position shown in the accompanying drawings. These terms are merely for the convenience of describing the present disclosure and simplifying the description, and not to indicate or imply that the device or element referred to needs to have a particular orientation, be constructed and operated in a particular orientation, and therefore cannot be understood as a limitation on the present disclosure.

In addition, the terms “first” and “second” are used merely for the purpose of description, and shall not be construed as indicating or implying relative importance or implying a number of indicated technical features. Therefore, features defining “first” and “second” may explicitly or implicitly include one or more such features. In the description of the present disclosure, “number of”, “multiple”, or “plurality of” means two or more, unless otherwise specifically defined.

In the present disclosure, terms such as “installation”, “connected”, “connection”, and “fastening” shall be understood in a broad sense unless otherwise expressly specified and defined, which for example, may be fixedly connected, detachably connected, or integrally formed; may be mechanically or electrically connected; may be directly connected or indirectly connected by an intermediate medium; or may be connection between two elements or interaction between two elements. For a person of ordinary skill in the art, specific meanings of the terms in the present disclosure may be understood based on a specific situation.

The present disclosure provides a battery core assembly 10, applied to a battery 100, and encapsulated in a casing 20 of the battery 100 as a battery core of the battery 100. At least one battery core assembly 10 is included. The battery core assembly 10 includes an encapsulation film 11 and an electrode core assembly 12. The electrode core assembly 12 is arranged in an accommodating cavity 110 defined by the encapsulation film 11, and the electrode core assembly 12 includes at least one electrode core 121.

The electrode core assembly 12 is provided with two electrode lead-out members 122 having opposite polarities for outputting a current.

A cap 13 is further arranged in the accommodating cavity 110 at a side of the electrode core assembly 12 having the electrode lead-out member 122, and is provided with an electrode lead-out hole 131 for the electrode lead-out member 122 to pass through. The electrode lead-out hole 131 penetrates through the cap 13.

Compared with related art, the present disclosure has the following beneficial effects.

In the battery core assembly 10, the cap 13 is arranged in the encapsulation film 11 at a side of the electrode core assembly 12 provided with the electrode lead-out member 122, and is provided with an electrode lead-out hole 131 for the electrode lead-out member 122 to pass through. The electrode lead-out member 122 is extended out of the electrode lead-out hole 131, to fix the electrode lead-out member 122 with the aid of the cap 13, so that the electrode lead-out member 122 is unlikely to wobble or move and the connection is stable and reliable. Therefore, the service life of the battery core assembly 10 can be extended.

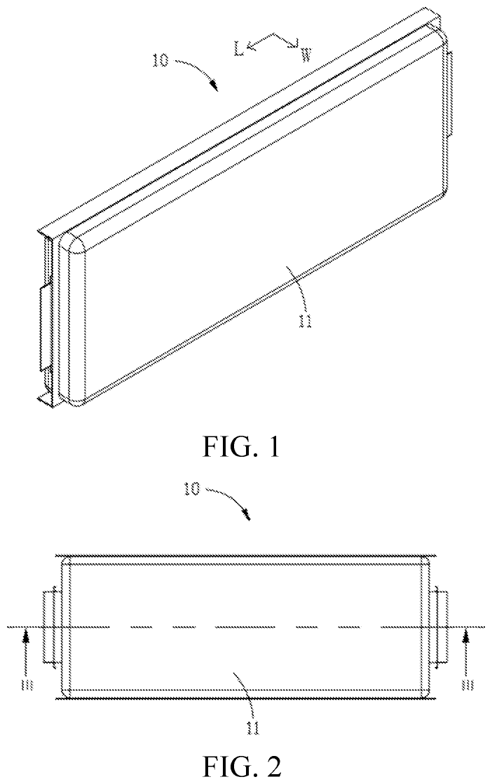

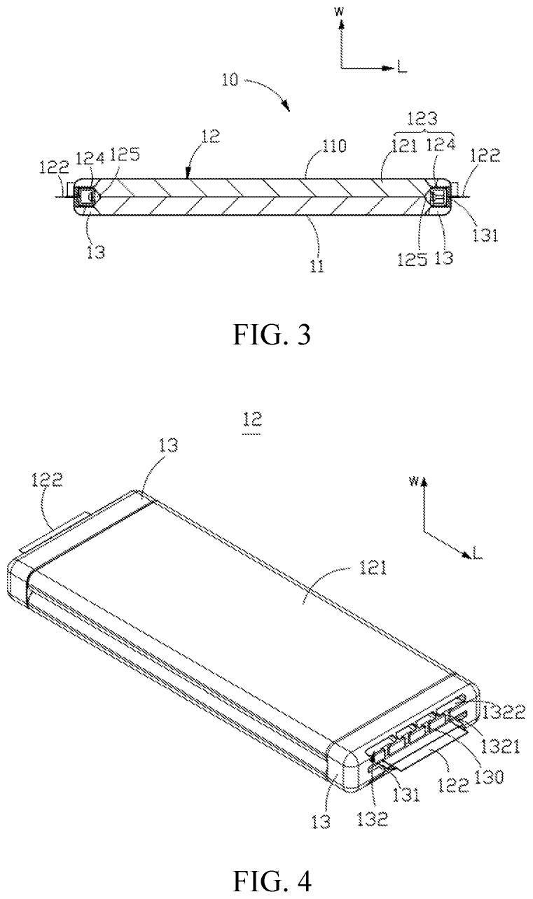

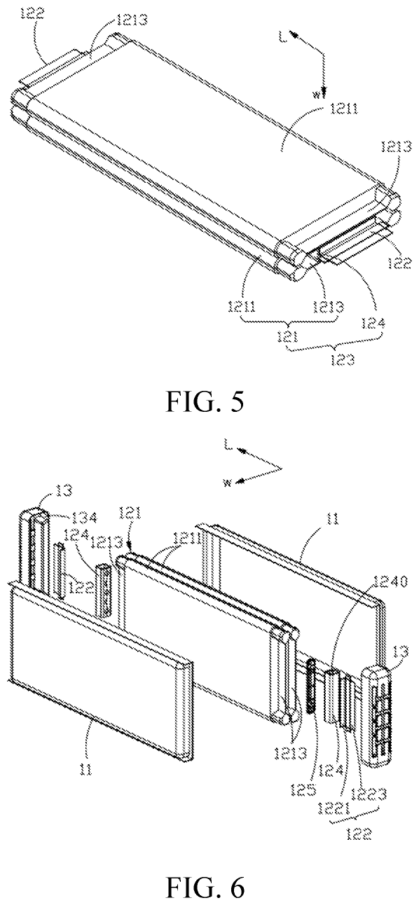

FIG. 1 is a schematic structural view of a battery core assembly 10 provided in a first embodiment of the present disclosure, FIG. 2 is a front view of the battery core assembly 10 shown in FIG. 1, and FIG. 3 is a schematic cross-sectional view of the battery core assembly 10 shown in FIG. 2 along Referring to FIGS. 1, 2 and 3, the battery core assembly 10 includes an encapsulation film 11 and an electrode core assembly 12. The encapsulation film 11 defines an accommodating cavity 110, and the electrode core assembly 12 is arranged or disposed in the accommodating cavity 110 and includes at least one electrode core 121. FIG. 4 is a schematic structural view of the battery core assembly 10 shown in FIG. 1 without the encapsulation film 11, that is, a schematic structural view of the electrode core assembly 12. FIG. 5 is a schematic structural view of the battery core assembly 10 shown in FIG. 4 without a cap 13. Referring to FIGS. 4 and 5, the electrode core assembly 12 is provided with two electrode lead-out members 122 of opposite polarities for outputting a current, where one of the two electrode lead-out members 122 is a positive electrode lead-out member, and the other is a negative electrode lead-out member. A cap 13 is further arranged in the accommodating cavity 110 at an end portion of the electrode core assembly 12 having the electrode lead-out member 122, and is provided with an electrode lead-out hole 131 for the electrode lead-out member 122 to pass through.

Therefore, in the embodiment of present disclosure, the cap 13 is arranged in the encapsulation film 11 of the battery core assembly 10 at an end portion of the electrode core assembly 12 having the electrode lead-out member 122, and is provided with an electrode lead-out hole 131 for the electrode lead-out member 122 to pass through. The electrode lead-out member 122 is extended out of the electrode lead-out hole 131, to fix the electrode lead-out member 122 with the aid of the cap 13. This can prevent the wobbling of the electrode lead-out member 122 to a certain extent, thus improving the stability and reliability of the connection of the electrode lead-out member 122, and extending the service life of the battery core assembly 10.

In some embodiments of the present disclosure, an electrolyte solution is injected/disposed in the accommodating cavity 110. It can be understood that after being injected into the accommodating cavity 110, the electrolyte solution fills a space between an inner surface of the encapsulation film 11 and an outer surface of the electrode core assembly 12. The cap 13 is provided with at least one first liquid reservoir 132, and the first liquid reservoir 132 is recessed from an outer surface of the cap 13 to the interior of the cap 13. The first liquid reservoir 132 communicates the accommodating cavity 110. As such, when an electrolyte solution is injected into the accommodating cavity 110, the electrolyte solution can enter the first liquid reservoir 132, to store additional electrolyte solution in the first liquid reservoir 132.

The content of the electrolyte solution in the battery may affect the service life of the battery. However, during the use of a battery, the electrolyte solution may gradually decrease due to expansion and other factors, affecting the service life of the battery. Moreover, lithium plating may also occur in some areas of the batteries, reducing the safety of the battery.

In the embodiment of present disclosure, the cap 13 is provided with the first liquid reservoir 132. When an electrolyte solution is injected into the encapsulation film 11, the first liquid reservoir 132 can store an amount of the electrolyte solution, to reduce the possibility of withdrawing free electrolyte solution when the encapsulation film 11 is vacuumed in the formation process of the battery core, and to maximize the amount of the electrolyte solution stored. Further, during long-term use of the battery, the electrolyte solution in the battery core assembly 10 can be replenished in time, to reduce the occurrence of lithium plating in the battery, and to improve the cycle life of the battery.

In some embodiments of the present disclosure, the cap 13 and the encapsulation film 11 are not hermetically connected, to allow the first liquid reservoir 132 to communicate with the accommodating cavity 110. In other words, the cap 13 is arranged in the encapsulation film 11, but an outer peripheral surface of the cap 13 and an inner surface of the encapsulation film 11 are not hermetically connected. Therefore, when an electrolyte solution is injected into the accommodating cavity 110 defined by the encapsulation film 11, the electrolyte solution can enter the first liquid reservoir 132, so the first liquid reservoir 132 can store an amount of the electrolyte solution.

In some embodiments of the present disclosure, multiple reinforcing ribs 1321 are provided in the first liquid reservoir 132, to divide the first liquid reservoir 132 into multiple liquid storage units 1322.

In some embodiments, three reinforcing ribs 1321 are provided. The three reinforcing ribs 1321 divide the first liquid reservoir 132 into four liquid storage units 1322. It can be understood that in other embodiments, the number of the reinforcing rib 1321 is not limited to 3, and may also be 1, 2, 4, or 5. The number of the liquid storage unit 1322 may be, but is not limited to, 4, and may also be less than 4 or more than 4.

Therefore, by arranging the reinforcing rib 1321 in the first liquid reservoir 132, the overall strength of the cap 13 can be enhanced, to enable the cap 13 to have a higher compressive strength.

In some embodiments of the present disclosure, the width of the four liquid storage units 1322 may be same or different. Therefore, the width of each liquid storage unit 1322 can be adjusted according to the arrangement between the liquid storage units 1322, to make the overall arrangement more reasonable.

In some embodiments of the present disclosure, for the electrolyte solution in each liquid storage unit 1322 to flow to the accommodating cavity 110, each liquid storage unit 1322 is provided with an opening 130, which facilitates the flow of the electrolyte solution from the liquid storage unit 1322.

In some embodiments of the present disclosure, the opening 130 enables the liquid storage unit 1322 to communicate with the electrode lead-out hole 131.

Therefore, the electrolyte solution in the liquid storage unit 1322 may flow easily out of the liquid storage unit 1322 and into the accommodating cavity 110.

In some embodiments of the present disclosure, the length of the electrode core 121 extends along a first direction L, and the thickness of the electrode core 121 extends along a second direction W perpendicular to the first direction L. Multiple first liquid reservoirs 132 are arranged along the second direction W.

In the present disclosure, the first direction refers to the length direction of the electrode core 121 in FIG. 1, that is, the L direction shown in FIG. 1. The second direction refers to the thickness direction of the electrode core 121 in FIG. 1, that is, the W direction shown in FIG. 1.

In this embodiment, two first liquid reservoirs 132 are provided, and the two first liquid reservoirs 132 are arranged along the second direction W, symmetrically at two opposite sides of the electrode lead-out hole 131.

It can be understood that in some embodiments of the present disclosure, the number of the first liquid reservoir 132 may be three or more, which is not limited herein.

As a result, the space on the cap 13 is fully utilized. More first liquid reservoirs 132 are provided while the strength of the cap 13 is ensured, so that more electrolyte solution can be stored, to reduce the occurrence of lithium plating in the battery, and to improve the cycle life of the battery.

In some embodiments of the present disclosure, referring to FIG. 4, the electrode core assembly 12 includes an electrode core assembly body 123 and an electrode lead-out member 122 electrically connected to the electrode core assembly body 123. The length of the electrode core assembly body 123 extends along the first direction L. Two caps 13 are provided, and the two caps 13 are respectively arranged at two opposite ends of the electrode core assembly body 123 in the first direction L. The two electrode lead-out members 122 respectively pass through two opposite sides of the electrode core assembly body 123 in the first direction L, and extend out of the electrode lead-out holes 131 of the corresponding caps 13.

Therefore, when two caps 13 are provided, and the two caps 13 are respectively arranged at two opposite ends of the electrode core assembly body 123 in the first direction L, multiple first liquid reservoirs 132 provide multiple storage spaces. Moreover, the two caps 13 are symmetrically arranged, so that the battery core assembly 10 has a symmetrical structure as a whole, is stressed evenly, and has a higher structural stability, a better compression resistance, and a better crash performance.

In some embodiments of the present disclosure, the cap 13 is mounted around the electrode core assembly body 123, that is, the two caps 13 are respectively mounted around two opposite ends of the electrode core assembly body 123 in the first direction L, as shown in FIG. 4. FIG. 6 is a schematic exploded view of the battery core assembly 10 provided in the first embodiment of the present disclosure. Referring to FIG. 6, the cap 13 has an accommodating space 134 at a side facing the electrode core assembly body 123. The two caps 13 are respectively mounted around two opposite ends of the electrode core assembly body 123 in the first direction L. The two opposite ends of the electrode core assembly body 123 in the first direction L are respectively fitted in the accommodating space 134 of the corresponding cap 13.

Therefore, the two caps 13 are respectively arranged at two opposite ends of the electrode core assembly body 123 in the first direction L, and respectively mounted around the two opposite ends of the electrode core assembly body 123 in first direction L. The two opposite ends of the electrode core assembly body 123 in the first direction L are respectively fitted in the accommodating space 134 of the corresponding cap 13, so that the structural stability is much higher.

In some embodiments of the present disclosure, one cap 13 is provided. Two electrode lead-out members 122 are extended out from one end of the electrode core assembly 12, and the cap 13 is arranged at the end of the electrode core assembly 12 having the electrode lead-out members 122. The cap 13 is provided with an electrode lead-out hole 131 for the two electrode lead-out members 122 to pass through.

Therefore, on the premise of ensuring the compressive performance of the battery core assembly 10, the number of the cap 13 can be reduced, to save the material cost.

According to some embodiments of the present disclosure, referring to FIG. 3 again, the length of the electrode core 121 extends along a first direction L, and the thickness of the electrode core 121 extends along a second direction W perpendicular to the first direction L. The electrode core assembly body 123 includes at least two electrode cores 121, and the at least two electrode cores 121 are arranged along the second direction W, where the electrode cores 121 are connected in series or in parallel. As shown in FIGS. 4-6, two electrode cores 121 connected in parallel, where the two electrode cores 121 are arranged along the thickness direction of the electrode core 121, that is, the second direction W.

In some embodiments of the present disclosure, two adjacent electrode cores 121 are connected in parallel. Each of the electrode cores 121 includes an electrode core body 1211 and two tabs 1213 of opposite polarities that are electrically connected to the electrode core body 1211. The two tabs 1213 are respectively arranged at two opposite ends of the electrode core body 1211 in the first direction L. One of the two tabs 1213 of the electrode core 121 is a positive electrode tab, and the other is a negative electrode tab.

The tabs 1213 with the same polarity of two adjacent electrode cores 121 are located at the same end in the first direction L and are electrically connected, to connect the two adjacent electrode cores 121 in parallel. Further, the positive electrode tabs 1213 of two adjacent electrode cores 121 are located at the same end in the first direction L, and the negative electrode tabs 1213 are located at the other end in the first direction L. Therefore, the adjacent two tabs 1213 at the same end are electrically connected to connect two adjacent electrode cores 121 in parallel.

In the present disclosure, the electrode core 121 can be an electrode core commonly used in the field of power batteries. The electrode core 121 and the electrode core assembly 12 are components inside the casing of a battery and cannot be understood as the battery itself. The electrode core 121 can be a winding electrode core 121, and the electrode core 121 generally refers to an assembly that is not fully sealed. Therefore, the battery of the present disclosure cannot be simply regarded as a battery module or battery assembly, just because it includes multiple electrode cores 121. In the present disclosure, the electrode core assembly 12 may include a single electrode core 121 or multiple electrode cores 121, where the multiple electrode cores 121 are connected in parallel, to form the electrode core assembly 12. For example, two electrode cores 121, four electrode cores 121, or eight electrode cores 121 are connected in parallel to form the electrode core assembly 12.

In some embodiments of the present disclosure, the electrode core assembly body 123 further includes a tab support 124 positioned between two adjacent tabs 1213 having the same polarity. The two adjacent tabs with the same polarity 1213 are respectively electrically connected to the tab support 124, that is, the two adjacent tabs 1213 at the same end are electrically connected by the tab support 124. As shown in FIG. 3, a tab support 124 is provided at both ends of the electrode core assembly 12 in the length direction.

Each of the electrode lead-out members 122 of the electrode core assembly 12 is electrically connected to one of the tab supports 124 located at one end of the electrode core assembly body 123 in the first direction L. It can be understood that when the electrode core assembly 12 includes three, four or even more electrode cores 121, multiple tab supports 124 may be provided at each end of the electrode core assembly 12 in the length direction. In the embodiment of present disclosure, the positive electrode lead-out member 122 of the electrode core assembly 12 is located at the same side of the electrode core assembly 12 with the positive electrode tab 1213, and electrically connected to the positive electrode tab 1213. The negative electrode lead-out member 122 is located at the other side of the electrode core assembly 12 with the negative electrode tab 1213, and electrically connected to the negative electrode tab 1213. According to some embodiments of the present disclosure, the electrode lead-out member 122 is electrically connected by one tab support 124 located the same side, so as to be electrically connected to the corresponding tab 1213.

For example, in the embodiment shown in FIG. 3 to FIG. 6, the electrode core assembly 12 includes two electrode cores 121. In this case, one tab support 124 is provided at each of the two opposite sides of the electrode core assembly 12 in the length direction L. The tab support 124 at each side of the electrode core assembly 12 is located between the two tabs 1213 at the same side, and electrically connected to the two tabs 1213 at the same side.

It can be understood that in some embodiments of the present disclosure, when two or more tab supports 124 are provided at the same side of the electrode cores 121, since two adjacent tab supports 124 at the same side are spaced apart by the tab 1213, for the purpose of electrically connecting the two adjacent tab supports 124, the tab support 124 needs to have a convex edge extending along the first direction L and beyond the edge of the tabs 1213 to electrically connect the adjacent two tab supports 124 through the contact of the convex edges.

In some embodiments of the present disclosure, referring to FIGS. 5 to 8, the tab support 124 is connected to the electrode lead-out member 122 and the tab 1213 at positions that are respectively located on different surfaces of the tab support 124. Namely, the electrode lead-out member 122 and the tab 1213 that are electrically connected to the same tab support 124 at positions respectively located on different surfaces of the tab support 124. Therefore, a situation is avoided where the electrode lead-out member 122 and the tab 1213 are both superimposed on the same surface of the tab support 124, to reduce the thickness at positions where the tab support 124 is connected to the electrode lead-out member 122 or the tab 1213.

In some embodiments of the present disclosure, the electrode lead-out member 122 includes a contact portion 1221 and a lead-out portion 1223. The contact portion 1221 is directly electrically connected to the tab support 124. The lead-out portion 1223 is drawn from the contact portion 1221 and extends along the first direction L. A part of the contact portion 1221 attached to the tab support 124 is plate-like, to increase the contact area between the contact portion 1221 and the tab support 124. As a result, the welded area between the tab support 124 and the contact portion 1221 is increased, to improve the connection reliability. In this embodiment, the lead-out portion 1223 is connected to one side of the contact portion 1221 in the first direction L to form an L-shaped bracket. It can be understood that in other embodiments, the lead-out portion 1223 is connected to a middle portion of the contact portion 1221 in the first direction L to form an L-shaped bracket. The contact portion 1221 of the electrode lead-out member 122 and the tab support 124 can be electrically connected by welding.

In some embodiments of the present disclosure, the tab support 124 includes two opposite first surfaces 1241, where the two first surfaces 1241 respectively face two adjacent tabs 1213 with the same polarity, and the two adjacent tabs 1213 with the same polarity are respectively directly attached to the two first surfaces 1241 of the tab support 124. The tab 1213 and the tab support 124 can be electrically connected by welding. By fixedly attaching the tab 1213 to the first surface 1241 of the tab support 124, the tab 1213 can be prevented from moving or shifting.

In some embodiments of the present disclosure, at least one tab support 124 connected to the electrode lead-out member 122 is a square piece, that is, the cross-section of the tab support 124 is of a square shape, and the tab support 124 has a cube structure. It can be understood that all the tab support 124 in the present disclosure can be the square piece. The tab support 124 of a square piece can provide a better support ability for the tabs 1213 between the adjacent tabs 1213, which can prevent the deformation of the tab support 124 during the welding process especially when the tab 1213 is welded to the tab support 124, and can increase the compression resistance of the tab support 124.

In some embodiments of the present disclosure, the square piece includes the two first surfaces 1241, a third surface 1243 located between the two first surfaces 1241 and facing the electrode core body 1211, and a fourth surface 1244 opposite to the third surface 1243.

The tab support 124 is electrically connected to the electrode lead-out member 122 through the fourth surface 1244. Specifically, the contact portion 1221 of the electrode lead-out member 122 is connected to the fourth surface 1244 of the tab support 124. Two adjacent tabs 1213 are respectively connected to the two first surfaces 1241. That is, the electrode lead-out member 122 and the tab 1213 are both in direct contact with and connected to the tab support 124 at positions located on different surfaces of the tab support 124. Therefore, a situation is avoided where the electrode lead-out member 122 and the tab 1213 are both superimposed on the same surface of the tab support 124, to reduce the thickness at positions where the tab support 124 is connected to the electrode lead-out member 122 and the tab 1213, and to facilitate the connection between the electrode lead-out member 122 and the tab support 124.

In some embodiments of the present disclosure, the interior of at least one tab support 124 is a hollow cavity 1240. For example, the interior of all the tab supports 124 can be a hollow cavity. The hollow tab support 124 can reduce the weight while ensuring the support strength.

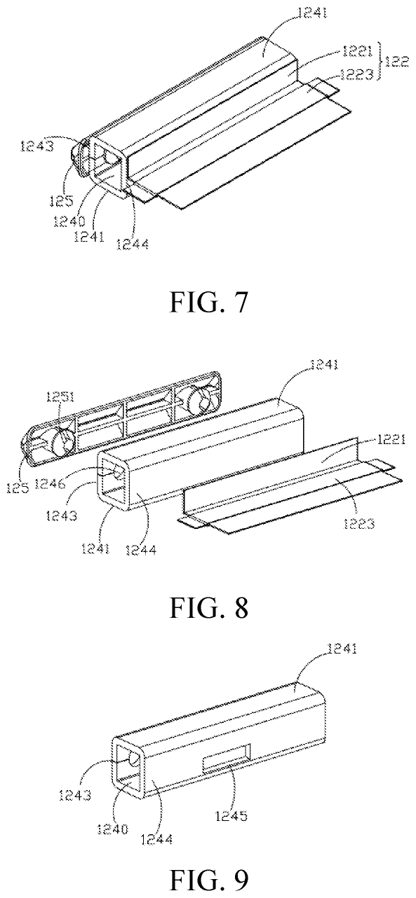

In some embodiments of the present disclosure, the hollow cavity 1240 is provided with an opening on at least one cavity wall. As shown in FIGS. 7 and 8, the hollow cavity 1240 can be provided with an opening on two end faces, where the opening communicates with the electrode lead-out hole 131 on the cap 13 located at the same side with the tab support 124, such that the hollow cavity 1240 is formed into a second liquid reservoir. As shown in FIG. 6, the electrode core assembly 12 is provided with a cap 13 at each of the two opposite sides in the first direction L. The two electrode lead-out member 122 of the electrode core assembly 12 are arranged at two opposite sides of the electrode core assembly 12 in the first direction L, and pass through from the electrode lead-out holes 131 of caps 13 at respective sides. By communicating the tab support 124 with the electrode lead-out hole 131 on the cap 13 at the same side, an electrolyte solution can enter via the electrode lead-out hole 131 into the hollow cavity 1240 communicating therewith, when the electrolyte solution is injected into the encapsulation film 11. Accordingly, the hollow cavity 1240 can be used to store the electrolyte solution, to attain a liquid storage function.

In some other embodiments, referring to FIG. 9, an opening 1245 may be provided on a cavity wall of the tab support 124 where the fourth surface 1244 is positioned, and the opening 1245 communicates with the electrode lead-out hole 131 on the cap 13 at the same side, such that the hollow cavity 1240 is formed into a second liquid reservoir. The arranging an opening communicating with the electrode lead-out hole 131 on a cavity wall where the fourth surface 1244 is positioned can further facilitate the flow of the electrolyte solution in and out of the hollow cavity 1240. Therefore, the liquid storage space is further increased by the second liquid reservoir.

In some embodiments of the present disclosure, referring to FIGS. 3, 6, 7 and 8, an insulating spacer 125 is provided between the tab support 124 and the electrode core body 1211. The insulating spacer 125 may electrically isolate the electrode core 121 and the tab support 124.

In some embodiments of the present disclosure, referring to FIG. 3 again, each of the two opposite ends of electrode core body 1211 in the first direction L has two surfaces forming a V-shaped end with a tip protruding outward, and the cross section of the V-shaped end is a V shape. The two tabs 1213 of each of the electrode cores 121 are respectively located at the tips of the two V-shaped ends, and a V-shaped space is formed between the V-shaped ends of the two adjacent electrode core bodies 1211 at the same end in the first direction L. The insulating spacer 125 is a V-shaped piece that has a shape matching the shape of the V-shaped space. The V-shaped piece is fitted in the V-shaped area. That is, the outer surfaces of the angled sides of the insulating spacer 125 are respectively attached to the two V-shaped ends forming the V-shaped space, to isolate the electrode core body 1211 and the tab support 124, and support the V-shaped ends of the electrode core body 1211, thereby protecting the electrode core assembly 12 against deformation due to collision.

In some embodiments of the present disclosure, the angle of the V-shaped space is 90-150 degrees. According to some embodiments of the present disclosure, for example, the angle may be in the range of 100-120 degrees or 120-145 degrees, and may be 95 degrees, 110 degrees, or 125 degrees, which is not limited herein.

In some other embodiments, the two opposite ends of the electrode core body 1211 in the first direction L can also be straight, square, or arc-shaped. Correspondingly, the shape of the insulating spacer 125 also needs to be adjusted for adapting the shape of the ends of the electrode core body 1211, which is not limited herein.

In some embodiments of the present disclosure, the insulating spacer 125 is fixed to the tab support 124 by a snap mechanism. In some embodiments, referring to FIG. 8, a buckle 1251 is provided on the insulating member 125, and an engaging hole 1246 is provided on the third surface 1243 of the tab support 124. The buckle 1251 is snapped into the engaging hole 1246 by extrusion deformation to form the snap connection. Two buckles 1251 may be provided, and two engaging holes 1246 may be provided, where the two buckles 1251 are respectively snapped into the two engaging holes 1246 to form the snap connection. Therefore, a firm connection is formed between the insulating member 125 and the tab support 124.

It should be noted that the insulating spacer 125 and the tab support 124 may be in contact with each other without being fixed by a fastener, or they can be fixed with each other by being pressed against each other through a reasonable spatial arrangement. Furthermore, the insulating spacer 125 and the tab support 124 can also be glued together, or fixed together in other ways, which is not limited herein.

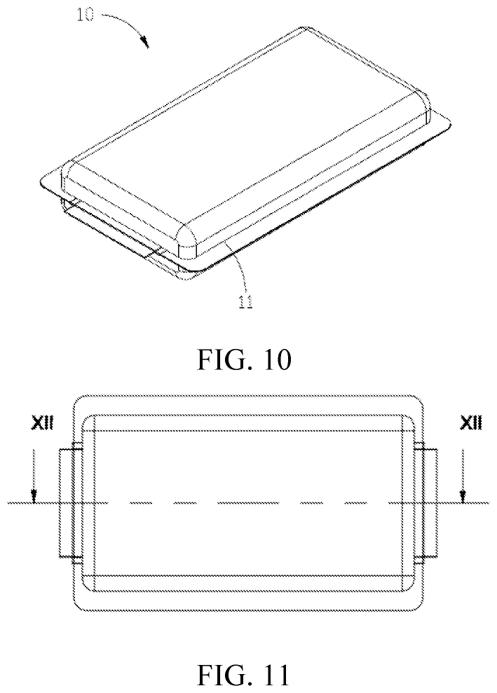

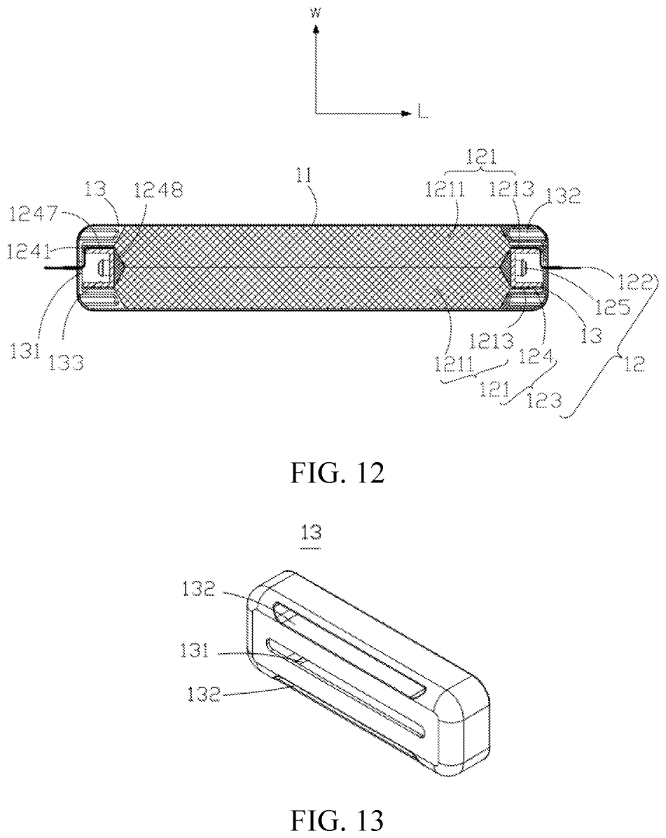

Referring to FIGS. 10, 11 and 12, FIG. 10 is a schematic structural perspective view of a battery core assembly 10 provided in a second embodiment. FIG. 11 is a front view of the battery core assembly 10 provided in the second embodiment, and FIG. 12 is a schematic cross-sectional view of the battery core assembly 10 provided in the second embodiment along XII-XII. The second embodiment differs from the first embodiment in that, the tab support 124 is a U-shaped piece, and the opening of the U-shaped piece is oriented parallel to the first direction

L. The U-shaped piece includes two opposite side walls 1247 and a bottom wall 1248 between the two opposite side walls 1247, and the outer surfaces of the two opposite side walls 1247 are the two first surfaces 1241 respectively. Namely, adjacent two tabs 1213 are respectively attached to the outer surfaces of the two opposite side walls 1247.

As shown in FIG. 12, the opening of the U-shaped piece faces the cap 13 at the same side. That is, the opening of the U-shaped piece is arranged to face away from the electrode core body 1211, and the tab support 124 is electrically connected to the electrode lead-out member 122 through one of the side walls 1247. In some embodiments, the portion of the electrode lead-out member 122 for the electrical connection with the tab support 124 is located between one of the tabs 1213 and a corresponding side wall 1247. That is, the electrode lead-out member 122 and one tab 1213 are stacked on and welded to the outer surface of one of the side walls 1247.

The opening of the U-shaped piece communicates with the electrode lead-out hole 131 on the cap 13 at the same side, such that an inner cavity 133 in the U-shaped piece is formed into a second liquid reservoir. Therefore, an auxiliary space for storing the electrolyte solution is further increased.

In some embodiments of the present disclosure, the opening of the U-shaped piece faces the electrode core body 1211, and the tab support 124 is electrically connected to the electrode lead-out member 122 through the bottom wall 1248.

In some embodiments of the present disclosure, an insulating spacer 125 is provided between the tab support 124 and the electrode core body 1211.

In some embodiments of the present disclosure, each of the two opposite ends of the electrode core body 1211 in the first direction L has two surfaces forming a V-shaped end with a tip protruding outward, and the cross section of the V-shaped end is a V shape. The two tabs 1213 of each of the electrode cores are respectively located at the tips of the two V-shaped ends, and a V-shaped space is formed between the V-shaped ends of the two adjacent electrode core bodies 1211 at the same end in the first direction L. The insulating spacer 125 is a V-shaped piece having a shape matching the shape of the V-shaped space. The V-shaped piece is fitted in the V-shaped area.

In some embodiments of the present disclosure, the angle of the V-shaped space is 90-150 degrees.

In some embodiments of the present disclosure, the two opposite ends of the electrode core body 1211 in the first direction L are straight, square, or arced. Correspondingly, the shape of the insulating spacer 125 also needs to be adjusted for adapting the shape of the ends of the electrode core body 1211, which is not limited herein.

In some embodiments of the present disclosure, the insulating spacer 125 is fixed to the tab support 124 by a snap mechanism.

In some embodiments of the present disclosure, a buckle 1251 is provided on the insulating member 125, and an engaging hole 1246 is provided on the third surface 1243 of the tab support 124. The buckle 1251 is pressed into the engaging hole 1246 by extrusion deformation to form a snap connection.

In this embodiment, two buckles 1251 may be provided, and two engaging holes 1246 may be provided, where the two buckles 1251 are respectively snapped into the two engaging holes 1246 to form the snap connection.

Therefore, a firm connection is formed between the insulating member 125 and the tab support 124. In this way, the insulating member 125 electrically isolate the tab support 124 and the electrode core body 1211.

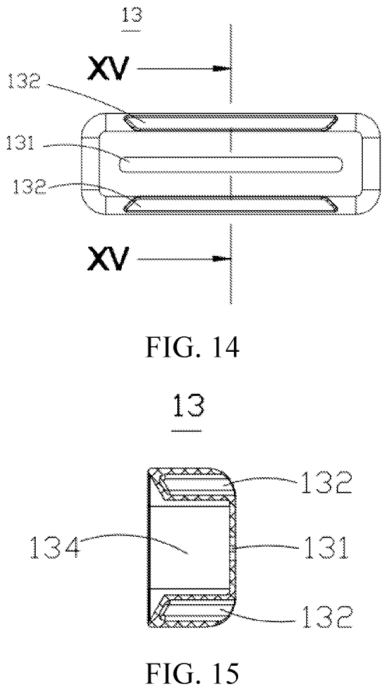

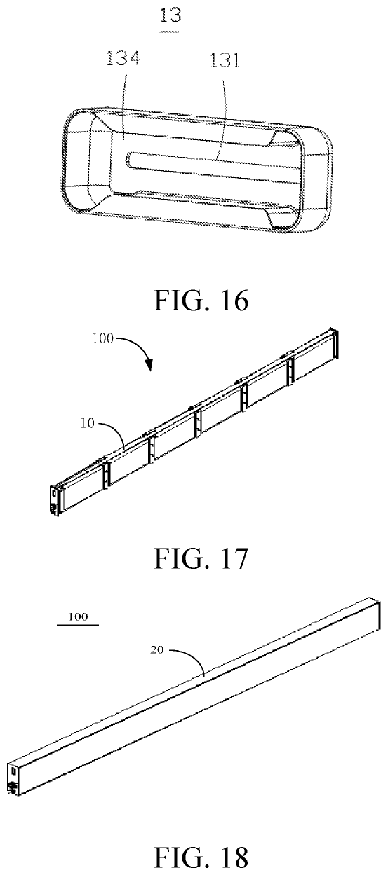

The second embodiment differs from the first embodiment in that no reinforcing ribs 1321 are arranged in the first liquid reservoir 132 as shown in FIGS. 13, 14, 15 and 16. Namely, the first liquid reservoir 132 includes only one liquid storage unit 1322. Two first liquid reservoirs 132 may be provided, and the two first liquid reservoirs 132 may be arranged along the second direction W, symmetrically at two opposite sides of the electrode lead-out hole 131.

In some embodiments of the present disclosure, the number of the first liquid reservoir 132 may be three or more, which is not limited herein.

Therefore, the space on the cap 13 is fully utilized, such that the cap 13 can store more electrolyte solution, to reduce the occurrence of lithium plating in the battery, to improve the cycle life of the battery, and to simplify the structure of the cap 13.

In some other embodiments, the opening of the U-shaped piece may also be oriented to face the electrode core body 1211. That is, the opening of the U-shaped piece is arranged adjacent to the electrode core body 1211, and the tab support 124 is electrically connected to the electrode lead-out member 122 through the bottom wall 1248. In other words, the tab support 124 is connected to the electrode lead-out member 122 and the tab 1213 at the positions that are respectively located on different surfaces of the tab support 124. This facilitates the electrical connection between the electrode lead-out member 122 and the tab support 124, and also reduces the thickness at the positions of connection.

Referring to FIGS. 17 and 18, in an embodiment provided in the present disclosure, the battery 100 includes a casing 20 and at least one battery core assembly 10 packaged in the casing 20. As shown in FIG. 17, multiple battery core assemblies 10 are encapsulated in the casing 20, and the multiple battery core assemblies 10 are arranged in sequence along a length direction of the battery 100. When the multiple battery core assemblies 10 are connected in series, the positive electrode lead-out member of one battery core assembly 10 is electrically connected to the negative electrode lead-out member of another battery core assembly 10, to connect the two battery core assemblies 10 in series. The battery core assembly 10 is a battery core assembly 10 as described in any of the foregoing embodiments.

In some embodiments of the present disclosure, the casing 20 is a metal casing, for example, an aluminum casing. Definitely, it may be formed of other metals as required.

In some embodiments of the present disclosure, the battery 100 is roughly a cuboid, and the battery 100 has a length L, a thickness W and a height H, where the length L is greater than the height H, and the height H is greater than the thickness W. The length of the battery 100 is 400-2500 mm, and the length to height ratio of the battery 100 is 4-21.

It should be noted that the battery 100 being roughly a cuboid means that the battery 100 may have a cuboid shape, a cube shape, a roughly cuboid shape or cube shape that is locally irregular, a generally approximate cuboid shape, or cube shape that locally has a notch, a bump, a chamfer, an arc portion, or a curved portion.

The present disclosure further provides a battery module, which includes multiple batteries 100 provided in the present disclosure.

The present disclosure further provides a battery pack 200, which includes multiple batteries 100 provided in the present disclosure or multiple battery modules provided in the present disclosure.

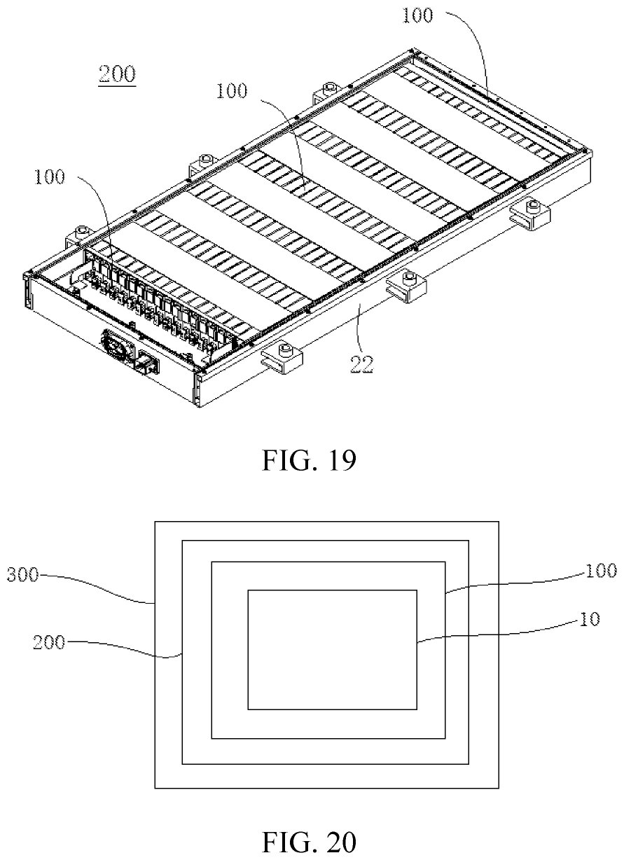

Referring to FIG. 19, the battery pack 200 provided in the present disclosure includes a tray 22 and the batteries 100 arranged on the tray 22.

The present disclosure further provides a vehicle 300 (see FIG. 20), which includes a battery module or a battery pack 200 provided in the present disclosure.

From the above, it can be seen that the present disclosure has excellent characteristics mentioned above, and has practical use due to the presence of the performances that are not found in related art, making the product of the present disclosure has a great practical value.

The foregoing descriptions are merely examples of embodiments of the present disclosure, but do not limit the present disclosure. Any modification, equivalent replacement, and improvement made without departing from the idea and principle of the present disclosure shall fall within the protection scope of the present disclosure.

What is claimed is:

1. A battery core assembly, comprising an encapsulation film and an electrode core assembly, wherein
the electrode core assembly is arranged in an accommodating cavity defined by the encapsulation film, and the electrode core assembly comprises at least one electrode core; and
the electrode core assembly comprises a first electrode lead-out member and a second electrode lead-out member for current output, and
a cap is arranged in the accommodating cavity at a first end portion of the electrode core assembly, the first end portion of the electrode core assembly has the first electrode lead-out member, and the cap comprises an electrode lead-out hole, wherein the first electrode lead-out member passes through the electrode lead-out hole.

2. The battery core assembly according to claim 1, wherein
an electrolyte solution is disposed in the accommodating cavity;
the cap comprises a first liquid reservoir, and the first liquid reservoir is a recess recessed from an outer surface of the cap to an interior of the cap; and
the first liquid reservoir communicates with the accommodating cavity.

3. The battery core assembly according to claim 2, wherein the cap and the encapsulation film are coupled to allow the first liquid reservoir to communicate with the accommodating cavity.

4. The battery core assembly according to claim 2, wherein the first liquid reservoir comprises a plurality of reinforcing ribs to divide the first liquid reservoir into a plurality of liquid storage units.

5. The battery core assembly according to claim 2, wherein
a length of the at least one electrode core extends along a first direction, and a thickness of the at least one electrode core extends along a second direction perpendicular to the first direction, and
the cap comprises a plurality of first liquid reservoirs including the first liquid reservoir, and the plurality of first liquid reservoirs are arranged along the second direction.

6. The battery core assembly according to claim 1, wherein
the electrode core assembly comprises an electrode core assembly body and two electrode lead-out members electrically connected to the electrode core assembly body, and a length of the electrode core assembly body extends along a first direction;
the two electrode lead-out members are respectively led out from two opposite end portions of the electrode core assembly body in the first direction; and
the battery core assembly comprises two caps including the cap, and the two caps are respectively arranged at the two opposite end portions of the electrode core assembly body in the first direction.

7. The battery core assembly according to claim 6, wherein
a length of the at least one electrode core extends along the first direction, and a thickness of the at least one electrode core extends along and a second direction perpendicular to the first direction, and
the electrode core assembly body comprises at least two electrode cores including the at least one electrode core, and the at least two electrode cores are connected and arranged along the second direction.

8. The battery core assembly according to claim 7, wherein
two adjacent electrode cores of the at least two electrode cores are connected in parallel,
each of the at least two electrode cores comprises an electrode core body and two tabs, and the two tabs have opposite polarities and are electrically connected to the electrode core body, wherein the two tabs are respectively arranged at two opposite ends of the electrode core body in the first direction, and
two adjacent tabs having a same polarity respectively of the two adjacent electrode cores are located on a same end of the electrode core body, and the two adjacent tabs are electrically connected.

9. The battery core assembly according to claim 8, wherein
the electrode core assembly body further comprises a tab support located on the end portions of the electrode core assembly body, and the tap support is electrically connected to and is disposed between the two adjacent tabs; and
the first electrode lead-out member is electrically connected to the tab support.

10. The battery core assembly according to claim 9, wherein the tab support is connected to the first electrode lead-out member and a corresponding tab on different surfaces of the tab support.

11. The battery core assembly according to claim 9, wherein the tab support comprises two first surfaces opposite to each other, and the two adjacent tabs are respectively attached to the two first surfaces of the tab support.

12. The battery core assembly according to claim 11, wherein the tab support is a square piece, the square piece comprises the two first surfaces, a third surface and a fourth surface located between the two first surfaces, and the third surface faces the electrode core body; and
the tab support is connected to the first electrode lead-out member through the fourth surface.

13. The battery core assembly according to claim 9, wherein the tab support has a hollow cavity.

14. The battery core assembly according to claim 13, wherein the hollow cavity has an opening on at least one cavity wall to communicate with the electrode lead-out hole on the cap, and the hollow cavity forms a second liquid reservoir.

15. The battery core assembly according to claim 11, wherein the tab support is a U-shaped piece having an opening, the U-shaped piece comprises two opposite side walls and a bottom wall between the two opposite side walls, and outer surfaces of the two opposite side walls are the two first surfaces respectively.

16. The battery core assembly according to claim 15, wherein the opening of the U-shaped piece faces the electrode core body, and the tab support electrically connected to the first electrode lead-out member through the bottom wall.

17. The battery core assembly according to claim 15, wherein the opening of the U-shaped piece faces the cap, and the tab support electrically connected to the first electrode lead-out member through one of the side walls.

18. The battery core assembly according to claim 15, wherein the opening of the U-shaped piece communicates with the electrode lead-out hole on the cap, and an cavity in the U-shaped piece forms a second liquid reservoir.

19. The battery core assembly according to claim 9, wherein an insulating spacer is disposed between the tab support and the electrode core body.

20. The battery core assembly according to claim 19, wherein
each of two opposite ends of the electrode core body in the first direction has a V-shaped end in a cross-sectional view with a tip protruding outward, the two tabs of each of the at least two electrode cores are respectively located at tips of the two V-shaped ends, and V-shaped ends of two adjacent electrode core bodies at a same end form a V-shaped space; and
the insulating spacer has a shape matching the V-shaped space.

21. The battery core assembly according to claim 20, wherein an angle of the V-shaped space is 90-150 degrees.

22. The battery core assembly according to claim 19, wherein the insulating spacer is fixed to the tab support by a snap mechanism.

23. The battery core assembly according to claim 6, wherein
the cap has an accommodating space on a side of the cap facing the electrode core assembly body, and
an end portion of the electrode core assembly body is fitted in the accommodating space of the cap.

24. A battery, comprising a casing, and at least one battery core assembly encapsulated in the casing, wherein the at least one battery core assembly comprises an encapsulation film and an electrode core assembly, and wherein
the electrode core assembly is arranged in an accommodating cavity defined by the encapsulation film, and the electrode core assembly comprises at least one electrode core; and
the electrode core assembly comprises a first electrode lead-out member and a second electrode lead-out member for current output, and
a cap is arranged in the accommodating cavity at a first end portion of the electrode core assembly, the first end portion of the electrode core assembly having the first electrode lead-out member, and the cap comprises an electrode lead-out hole, wherein the first electrode lead-out member passes through the electrode lead-out hole.

25. A battery pack, comprising a plurality of batteries, wherein each of the plurality of batteries comprises the battery according to claim 24.

26. A vehicle, comprising a battery comprising a casing, and at least one battery core assembly encapsulated in the casing, wherein the at least one battery core assembly comprises an encapsulation film and an electrode core assembly, and wherein
the electrode core assembly is arranged in an accommodating cavity defined by the encapsulation film, and the electrode core assembly comprises at least one electrode core; and
the electrode core assembly comprises a first electrode lead-out member and a second electrode lead-out member for current output, and
a cap is arranged in the accommodating cavity at a first end portion of the electrode core assembly, the first end portion of the electrode core assembly having the first electrode lead-out member, and the cap comprises an electrode lead-out hole, wherein the first electrode lead-out member passes through the electrode lead-out hole.
